(19) United States
(12) Patent Application Publication
(10) Pub. No.: US 2026/0225331 A1
(43) Pub. Date: Aug. 6, 2026

(54) POLYIMIDE COMPOSITE REPAIR APPARATUS AND METHOD VIA HIGH TEMPERATURE RESIN TRANSFER MOLDING

(71) Applicant: RTX Corporation, Farmington, CT (US)

(72) Inventors: Xiaomei Fang, South Glastonbury, CT (US); Matthew Robert Zsunkan, Hartford, CT (US)

(73) Assignee: RTX Corporation, Farmington, CT (US)

(21) Appl. No.: 19/152,258

(22) PCT Filed: Jan. 30, 2024
(86) PCT No.: PCT/US2024/013476

§ 371 Date: Jul. 30, 2025

Related U.S. Application Data
(60) Provisional application No. 63/442,318, filed on Jan. 31, 2023.

(51) Int. Cl. B29C 70/48; B29K 79/00; B29K 105/08; B29K 307/04

(52) U.S. Cl. CPC B29C 70/48; B29K 2079/08; B29K 2105/0809; B29K 2307/04

(57) ABSTRACT

An apparatus (50) for repairing a defective area in a polyimide composite (54) component includes a flexible film (56) enclosure for covering the defective area (52) of the polyimide composite component; a seal (62) around a perimeter of the film; a resin injection assembly (60) for injecting resin between the flexible film enclosure and the defective area of the component; and a vacuum source (58) for drawing vacuum between the flexible film enclosure and the component. A method is also disclosed.

### BACKGROUND OF THE DISCLOSURE

High temperature polymeric composites provide unique advantages over metals in weight savings and durability, for example in manufacturing of aerospace components such as components of gas turbine engines and the like.

Thermosetting polyimide composites offer very high temperature capability among the polymeric composite structures to date. However, the polyimide materials used to fabricate such high temperature composite parts are prepreg components wherein the manufacture process involves high viscosity materials and a high level of solvent contents. Thus, high levels of volatiles are generated during the fabrication processing. When a component fabricated in this manner needs repair, it is difficult to perform repair processes or achieve a decent repair quality using such high viscosity and volatile content materials.

Resin transfer molding (RTM) introduces liquid resin into the dry fabrics, and the resin is infused into the dry fabrics through an injector pressure. Traditionally, rigid metal molds are required to hold high pressure during the RTM process. Such rigid metal molds are required to be designed and built individually according to each specific part geometry. As a result, it would be costly and time consuming to adapt such rigid metal molds for general composite repairs on a variety of part locations and part geometries.

### SUMMARY OF THE DISCLOSURE

The present disclosure relates to repair of thermosetting polyimide composite components using a resin transfer molding (RTM) process, and to an apparatus for such repair.

As disclosed herein, a polyimide-based RTM process can be adapted to use in repairing polyimide composite components, bringing manufacturing benefits to repair of high temperature composites for complex and tight tolerance parts.

As will be further discussed below, an apparatus for polyimide composite repair can include one or more resin injectors for generating resin flow at or above the melt temperature of the resin, one or more solid flat or curved resin inlet plates for receiving resin from the resin injectors, a flexible film enclosure or tool segment for establishing an isolated zone around a defective area to be repaired, a seal which seals the flexible film enclosure or tool segment relative to a resin inlet and/or the resin inlet plate, a flow media or porous release fabric spread on the defective area to be repaired, and configured to receive resin from the resin inlet and distribute the resin into the defective area. A vacuum line is positioned to pull a vacuum from between the flexible film enclosure and an area surrounding the defective area, and a breather structure is positioned around the defective area to distribute the vacuum to the entire perimeter and thereby help seal the flexible film enclosure around the defective area to be repaired. In one optional configuration, a membrane can be positioned on top of the flow media, the membrane being breathable to air to allow air bubbles to escape from the resin, but to not allow resin to pass. Further, additional clamp force can be applied to seal the flexible film enclosure to the underlying component if desired or necessary. The flexible tool segment or flexible film enclosure allows the apparatus to be used with different contours of components such as, by way of non-limiting example, airfoil surface contours and various part geometries that may have defective areas to be repaired. A method is also disclosed. Further, the resin materials used for the repair can advantageously be free of solvent content, with no significant volatile generation during the cure.

In one embodiment, an apparatus for repairing a defective area in a polyimide composite component comprises a flexible film enclosure for covering the defective area of the polyimide composite component; a seal around a perimeter of the film; a resin injection assembly for injecting resin between the flexible film enclosure and the defective area of the component; and a vacuum source for drawing vacuum between the flexible film enclosure and the component.

In one non-limiting configuration, the apparatus further comprises a resin injection machine connected to the resin injection assembly.

In another non-limiting configuration, the resin injection assembly comprises a resin line connected to the resin injection machine, a resin nozzle for injecting resin between the flexible film enclosure and the defective area, and a resin plate extending laterally from the resin nozzle for sealing against the flexible film enclosure on one side and guiding flow of resin on the other side.

In still another non-limiting configuration, the resin nozzle passes through the resin plate.

In a further non-limiting configuration, the vacuum source comprises a vacuum pump communicated with a space between the flexible film enclosure and the component.

In a still further non-limiting configuration, the resin plate comprises a plate having a shape to match a surface of the defective area.

In another non-limiting configuration, the resin plate is flat.

In still another non-limiting configuration, the flexible film enclosure comprises a material selected from the group consisting of polyimide film, aluminum foil and combinations thereof.

In a further non-limiting configuration, the apparatus further comprises a breather structure positioned around a perimeter of the defective area of the component and communicated with the vacuum source.

In a still further non-limiting configuration, the apparatus further comprises a porous flow media between the resin injection assembly and the defective area.

In another non-limiting configuration, the apparatus further comprises a solid release fabric around a perimeter of the defective area.

In still another non-limiting configuration, the apparatus further comprises an additional flexible film enclosure for covering an opposite side of a defective area of a component.

In a further non-limiting configuration, the apparatus further comprises an additional seal around a perimeter of the additional flexible film enclosure; an additional resin injection assembly for injecting resin between the additional flexible film enclosure and the opposite side of the defective area of the component; and a vacuum source for drawing vacuum between the additional flexible film enclosure and the opposite side of the defective area of the component.

In another non-limiting embodiment, a method for repairing a defective area of a polyimide composite component, comprises the steps of establishing a resin transfer molding area around the defective area; and injecting resin above a melting temperature of the resin into the defective area.

In one non-limiting configuration, the method further comprises adding a fabric media to the defective area whereby the injecting step injects resin through the fabric media.

In another non-limiting configuration, the method further comprises removing damaged plies from the defective area before the adding step.

In still another non-limiting configuration, the fabric media is selected from the group consisting of chopped glass, carbon or quartz fiber, glass, quartz or carbon fabric preforms, continuous glass, quartz or carbon fabric and combinations thereof.

In a further non-limiting configuration, the fabric media is continuous carbon fabric.

In a still further non-limiting configuration, the step of establishing a resin transfer molding area comprises surrounding the defective area with a flexible film enclosure to define the resin transfer molding area between a component surface and the flexible film enclosure.

In another non-limiting configuration, the injecting step comprises injecting the resin through a resin inlet into the resin transfer molding area.

In still another non-limiting configuration, the method further comprises holding vacuum in the resin transfer molding area wherein the flexible film enclosure is pulled toward the component around the defective area.

In a further non-limiting configuration, the method further comprises, after the injecting step, curing injected resin at the defective area by holding the resin transfer molding area at a curing temperature to cure the injected resin in the defective area.

In a still further non-limiting configuration, the injecting step comprises injecting resin at a temperature of at least 500° F.

In another non-limiting configuration, the injecting temperature is between 500 and 550° F.

In still another non-limiting configuration, the curing temperature is at least 650° F.

In a further non-limiting configuration, the curing temperature is between 650 and 750° F.

In a still further non-limiting configuration, the injecting step comprises injecting resin through an injection nozzle connected to an injection machine, and further comprising disconnecting the injection machine before the curing step.

In another non-limiting configuration, the method further comprises, before the step of establishing the resin transfer molding area, applying a solid release fabric around a perimeter of the defective area, and then applying a porous flow media over the defective area and overlapping the release fabric, wherein the injecting step injects resin through the porous flow media and into the defective area.

In still another non-limiting configuration, the method further comprises removing the release fabric and the perforated release fabric after the injecting step whereby excess resin is removed.

The foregoing features and elements may be combined in various combinations without exclusivity, unless expressly indicated otherwise. These features and elements, as well as the operation thereof, will become more apparent in light of the following description and the accompanying drawings. It should be appreciated that the following description and drawings are intended to be exemplary in nature and non-limiting.

### BRIEF DESCRIPTION OF THE DRAWINGS

A detailed description of non-limiting embodiments of the present disclosure follows, with reference to the attached drawings, wherein:

FIGS. 1-3 illustrate different types of defective areas in polyimide composite components;

FIG. 4 illustrates a system or apparatus for repair of a defective area of a polyimide composite component;

FIGS. 5 and 6 further illustrate the system of FIG. 4;

FIGS. 7 and 8 are top views corresponding to FIGS. 5 and 6; and

FIGS. 9-14 illustrate steps in the method for repair as disclosed herein.

### DETAILED DESCRIPTION

The disclosure relates to a repair process using resin transfer molding (RTM) and polyimide resin to repair polyimide composite structures.

Polyimide composite components can be very useful in numerous applications due to numerous advantageous properties including high temperature resistance and low weight, for example as compared to metal and metal alloy components. Examples of such components include but are not limited to components of gas turbine engines such as split fan ducts, fan cases, compressor cases, stators for compressors, flaps, turbine blades and the like. The combination of toughness, temperature resistance and light weight makes polyimide composite particularly well suited to such components.

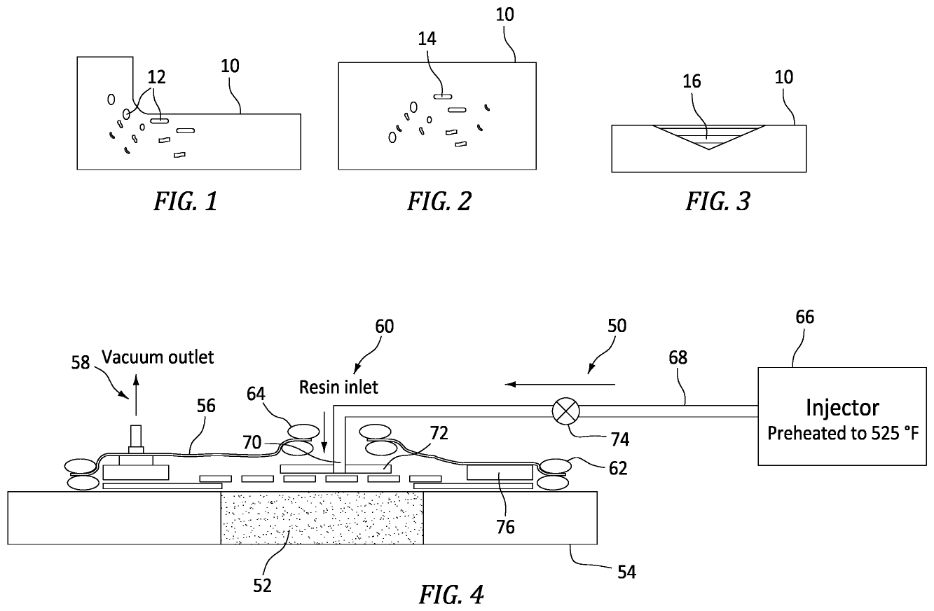

For various reasons, polyimide composite components can develop defective areas during or after production or in service. These defective areas can be worn areas due to use of the component, or issues arising from initial manufacture, or other damage that can occur during use. FIGS. 1-3 illustrate different non-limiting examples of defective areas. In addition to those examples shown in FIGS. 1-3, there are other types of defective areas and the present disclosure is not limited to use with the illustrated examples of defective areas.

In FIG. 1, a component 10 is shown having areas 12 of interlaminar voids and/or delamination. FIG. 2 shows a component 10 having surface voids or dry spots 14. FIG. 3 shows a component 10 requiring a scarf repair after removal of damaged plies, leaving a pit or depression 16 in component 10. All these types of defective areas, and others, can be repaired using the method and apparatus as disclosed herein. Further, this repair is accomplished without the need for working with particularly high viscosity materials, or materials that require a large degree of solvents and lead to large amounts of volatiles.

As disclosed herein, these defective areas are repaired using a polyimide composite resin transfer molding (RTM) process which fills the interlaminar voids and delamination areas 12, the surface voids or dry spots 14, and/or the pit or depression 16 in component 10. The polyimide composite resin can be selected to have good RTM properties during injection, and also good properties during curing, for example such that there are little or no volatiles released during curing.

FIG. 4 shows an apparatus 50 that can be used to carry out an RTM repair of a defective area 52 of polyimide component 54. As shown, apparatus 50 can comprise a flexible film enclosure 56 that can be used to create a resin transfer repair area by being positioned over defective area 52. Pressure difference can be used to hold flexible film enclosure 56 in place, and this can be applied for example using a vacuum source 58 which can pull vacuum from between film enclosure 56 and underlying component 54, or in numerous other ways such as applying additional pressure from outside of film enclosure 56, which can be done using a second flexible film or bag to create a greater pressure outside of film 56 and thereby press film 56 against a surface of component 54.

The apparatus also has a resin inlet assembly 60. Resin inlet assembly 60 can be connected to an injector or injection machine 66, which can be used to produce and provide resin at a temperature above the resin melting temperature, and at a pressure sufficient to pump the resin into the defective area 52 as further discussed below. A seal 62 can be disposed around a perimeter of the flexible film enclosure 56 and used to further establish a resin transfer molding area or zone over the defective area 52. A further seal 64 can be arranged to seal around resin inlet 60. Injector 66 can be connected to resin inlet assembly 60 via an injection line 68. Resin inlet assembly 60 can comprise a resin nozzle 70 which can be a tube for carrying resin to be injected, and a resin plate 72 which can extend substantially laterally from resin nozzle 70 and serves to both seal against flexible film enclosure 56 on one surface, and on the other surface to guide injected resin into the defective area 52 to be repaired. Resin plate 72 can have any suitable shape and size, but is suitably shaped to match a surface of the component to be repaired, and also to have sufficient surface area to effectively seal against flexible film 56 and cover at least a portion of the defective area as well. Depending upon the surface to be treated, resin plate 72 can be flat or curved, and can have an outer shape that is rectangular, or round, or any other suitable shape again designed to match the surface of the component and to establish a good seal with flexible film 56.

Injector 66 can be any suitable injector of high temperature materials and should be compatible with high temperature resin, specifically resin at a temperature that is higher than the glass transition temperature for that resin. With a polyimide resin, such temperatures can be 500° F. or greater, for example between 500 and 550° F. Injection line 68 should also be well suited to carrying polyimide resin at these temperatures, and can have a valve 74 which, as discussed below, can also serve as a connection/disconnection point. Nozzle 70 and plate 72 are also made of suitable material to handle the high temperature resin, and also these components should be well suited to exposure to curing temperatures of the polyimide resin as well up to 700° F. These components can therefore be fabricated from metal or metals with these properties. Composites or other material format containing this temperature capability can be considered as well.

Plate 72 can in one non-limiting configuration be flat or curved. In other configurations, it may be useful, for example with complex surface structures on components to be repaired, for plate 72 to have a different shape to match the surface of the defective area. The outside edge of plate 72 can be configured to any suitable shape. In the illustrated embodiment, see also FIGS. 7 and 8, plate 72 can be generally rectangular as illustrated or can be round in another non-limiting example.

In use, when vacuum is applied by vacuum source 58, pressure differential between the vacuum established between film 56 and component 54 on the one hand, and ambient or outside of film 56 on the other hand, serves to press film 56 toward component 54. This is desirable as it helps to guide resin from nozzle 70 toward the defective area 52 rather than out along the outside of the component. As mentioned above, in some configurations it may be desirable to increase the pressure outside of film 56 to increase the pressure differential and further press film 56 toward component 54. This can be useful, for example, to help keep film 56 in place during injection of resin. Increasing the outside pressure can be accomplished in various ways that would be known to persons skilled in the art, including providing a second membrane or film (not shown) outside of film 56 and modifying the pressure within the second membrane.

Film 56 can be any film suitably durable and capable of withstanding high temperatures of the resin with which it can come in contact. Non-limiting examples of suitable film include polyimide film, aluminum foil and other materials with suitable drapability and temperature capability. One suitable example of a polyimide film is Kapton film. Of course, thin aluminum foil or other films as mentioned above are suitable.

Seals 62, 64 can be provided to help seal film 56 around a perimeter of the defective area 52 and also to help seal film 56 around resin inlet assembly 60. Any suitable seal can be utilized such as, but not limited to, high temperature tacky tape, O-rings or the like, and additional clamp pressure can also be applied to mechanically improve the seal if necessary.

While not illustrated in the drawings, a curing apparatus is also useful, and could be an autoclave, an oven, an infrared lamp or any other well-known apparatus which can hold component 54 at the desired curing temperature, which can be as much as 650° F. or higher, and in one non-limiting configuration can be between 650 and 750° F. For components of suitable size, autoclaves and ovens can be utilized. When defective areas on larger parts are being repaired, or if a component is to be repaired in situ or on wing, then directed curing such as from an IR lamp can be suitable.

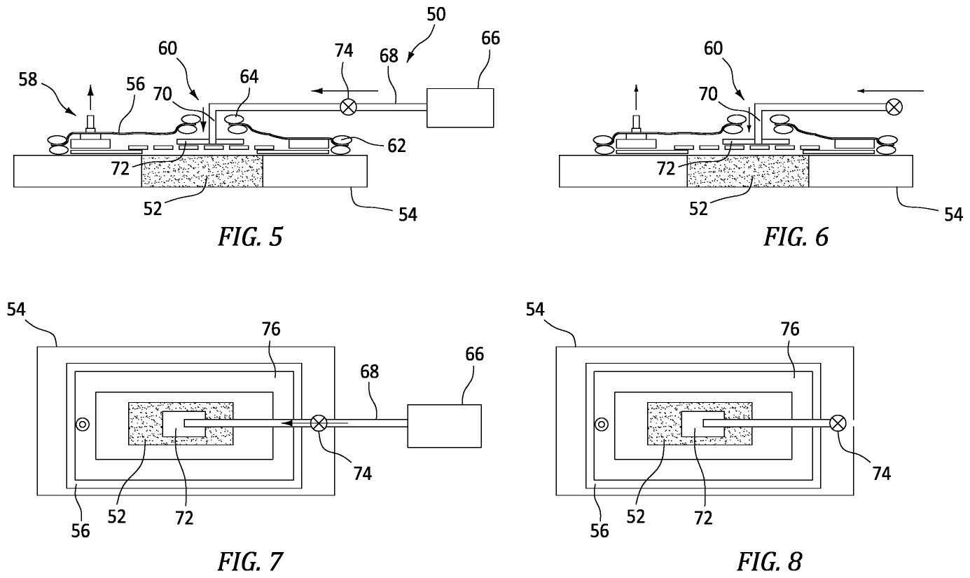

Referring now also to FIGS. 5-8, further illustrations of the apparatus 50 as shown in FIG. 4 are provided. FIG. 5 is similar to FIG. 4, while FIG. 7 shows a top view of apparatus 50 of FIG. 4.

Note the shape of plate 72 in this embodiment is rectangular, but again other shapes can be utilized. It is also noted that in this configuration, a breather structure 76 is shown which can be any suitable structure to allow vacuum applied by vacuum source 58 to extend around the perimeter of film 56 and defective area 52 and help to secure film 56 relative to component 54 as desired. Breather structure 76 can be any suitable structure that maintains a small space between a surface of component 54 and film 56 such that vacuum can extend around and along breather structure 76. This generates a vacuum zone extending along breather structure 76, and in this configuration the vacuum zone extends around a perimeter of the defective area of the component, and also has a width in-plane with the surface of the defective area, whereby film 56 can be subjected to a pressure differential outside of film 56 as compared to inside film 56, that is, between film 56 and component 54. This pressure differential helps to press film 56 toward component 54 as desired and as mentioned above.

FIGS. 5-6 and 7-8 also further illustrate that injector 66 can be disconnected from line 68. FIGS. 5 and 7 show injector 66 connected, and FIGS. 6 and 8 shows injector 66 disconnected. This can be done, for example, at valve 74 which can also be a disconnect device. Disconnecting injector 66 can be helpful as once the resin is injected as desired, the component with injected repair resin should be cured at temperatures of at least 650° F., for example in the range of 650-750° F., and in one non-limiting configuration, a curing temperature of as high as 700° F. is suitable. Since injector 66 can be both too bulky and not capable of withstanding such temperatures, it is therefore useful that injector 66 can be disconnected from line 68 before being placed in a curing step such as in an autoclave or the like.

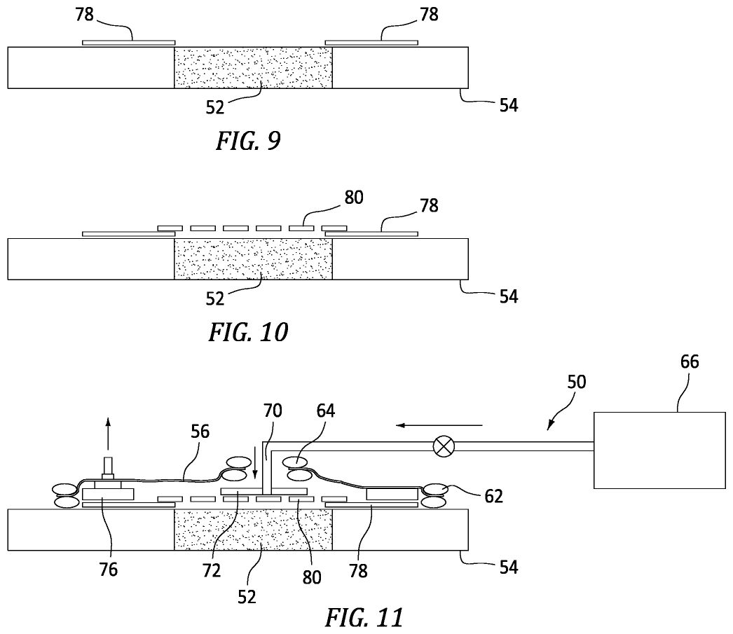

FIGS. 9-14 sequentially illustrate the method. Starting with FIG. 9, a component 54 having a defective area 52 is prepared for repair. This can include cleaning the surface, removing of any fabric or other material such as damaged plies that is/are too damaged to remain, and adding fabric material to the area as needed, for example in the case of a pit or depression 16 as shown in FIG. 3. Any fabric material to be added can be in the form of fabric media selected from the group consisting of chopped carbon, quartz or glass fibers, continuous carbon, quartz or glass fabric, and one particularly useful fabric media is a continuous carbon fabric which can help to maintain the structural strength of the component being repaired.

Still referring to FIG. 9, a release fabric 78, which can for example be a solid Teflon material, can be applied to component 54 around the defective area 52. Release fabric 78 can be a solid Teflon or other treated solid fabric that will help to provide removal if or when needed if any resin escapes the repair area and flows over the outer surface of release fabric 78.

FIG. 10 shows that next, a perforated or porous release media or fabric 80 can be positioned over defective area 52 and partially overlapping release fabric 78. The porousness or perforation is selected to allow resin injected into or against the perforated or porous fabric to pass through the fabric and thereby reach the defective area 52 as desired and facilitate resin distribution in the defective area 52. While both porous and perforated release fabric or media 80 can be useful, it is desirable that resin can flow through porous media 80 both directly across the media or fabric, and also laterally through the fabric, and therefore a media that is porous in both of these flow directions can be useful.

Turning to FIG. 11, an apparatus 50 as disclosed herein can then be installed or applied to component 54 to establish a resin transfer molding area around defective area 52. This can be done with flexible film enclosure 56 positioned over defective area 52, with seals 62 around a perimeter of film 56 around the defective area, and with either or both of pressure differential (once vacuum is applied) and seals 62 sealing film 56 against the surface of component 54.

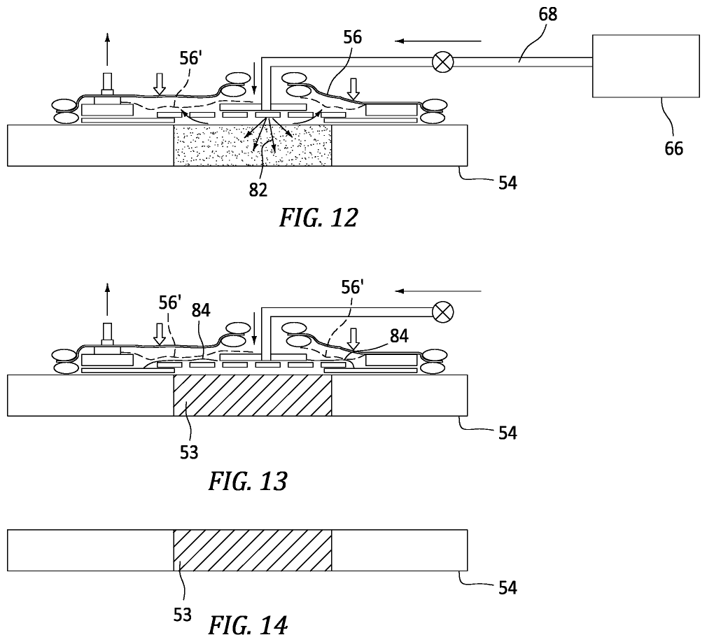

Referring to FIG. 12, a vacuum can now be applied to the space defined between film 56 and component 54. Turning to FIG. 12, film 56 is schematically illustrated being pulled down onto a surface of the component, see broken line 56′ referring to the movement of film 56 due to the vacuum. At this stage, resin can be injected from injector 66 through line 68 and resin nozzle 70 to be positioned as desired by plate 72 and porous media 80. Arrows 82 show expected injection path of the resin from resin nozzle 70. It is noted that the majority of resin in this configuration passes through porous media 80 and enters the site of the defective area 52. Once injection is complete, injector 66 can be removed (FIG. 13), and the structure can be subjected to a high temperature cure step, for example at a temperature of as much as 700° F. Vacuum can still be held within film 56 during this curing step, if desired.

Finally, the apparatus 50 can be removed, leaving only release fabric 78 and porous media 80, as well as a small portion of resin 84 (FIG. 13). Peeling of the release fabric 78 and porous media 80 removes any excess material or excess resin 84 that did not pass into the defective area. Thus, any needed treatment of the repaired surface at this stage is minimal, specifically only dealing with remaining fabric patterns that might be present in the repaired component surface. If this is the case, conventional methods can be used to remove any materials needed. Thus, the process is completed with a component 54 having a repaired section 53 in place of defective area 52.

The above disclosure is made in terms of repair of a defective area 52 that does not pass through the entire thickness of a component. In some instances, this will not be the case, and defects could extend through the thickness of the component. When this occurs, it may be useful to deploy two apparatus 50 as disclosed herein such that one encloses one surface of the defective area and the other encloses the other surface of the defective area. In this manner, resin can still be reliably injected into the defective area without escaping during injection. When an additional apparatus is to be used as mentioned herein, this can include using an additional flexible film enclosure and as many additional other components as are necessary, such as an additional resin inlet assembly, breather structure and the like. The actual source of resin can be the same injector 66 or can be an additional injector if preferable.

Polyimide RTM processes can be applied to repair high temperature composite parts. Low viscosity and volatile free polyimide materials allow a feasible path for polyimide composite repair and rework. The main damages/defects on polyimide composite parts include delamination, interlaminar voids, surface voids, dry spots and fiber distortion and breakage. For fiber damage, scarf joints are typically applied by removing fibers and adding new reinforcement. Imide oligomers with cross-link end groups are used as polyimide RTM resins. The high temperature RTM process is built with high temperature injector, flattened resin inlet which can be rigid, flexible film bagging, high porous fabric to distribute resin, vacuum outlet, breather to distribute vacuum path. High temperature elastomer tacky tape or elastomer O-ring can be used to seal flexible bagging. Flexible bagging is adopted to accommodate different part geometries. Additional clamp pressure can be added to improve the seal. A dead zone can be applied to ensure better resin infiltration into the damaged repair area. Dead zone is defined as a distance between porous media 80 and breather structure 76 (FIG. 11 for example) and this dead zone can be 1 inch or greater in width. The injector temperature can be in a range of 500 to 550° F. The injector pressure is controlled to 5 psi to 50 psi, 5 psi to 20 psi. The repair composite portion can be heated to 525° F. during the RTM process, and up to 700° F. during cure process. The cure process can be performed inside an oven, or using a local heating source such as an IR lamp.

The disclosed polyimide RTM repair process can provide a repeatable and reliable process for high temperature polyimide repair. High repair quality can be achieved using low viscosity and volatile-free polyimide oligomers through high temperature RTM process. LOW viscosity promotes infiltration through fine gaps/voids. Volatile-free resins also reduce porosity formation during the cure process. Polyimide RTM repair process provides a feasible and cost-saving path to rebuild acceptable composite surface smoothness and repair high temperature polyimide composites containing local damage. The combination of high temperature injection, rigid resin inlet and flexible bagging allows this repair process to be applied to a variety of part geometries and shapes.

The foregoing description is exemplary of the subject matter of the subject matter disclosed herein. Various non-limiting embodiments are disclosed, however, one of ordinary skill in the art would recognize that various modifications and variations in light of the above teachings will fall within the scope of the appended claims. It is therefore to be appreciated that within the scope of the appended claims, the disclosure may be practiced other than as specifically described. Thus, the scope of the present claims is not specifically limited by the details of specific embodiment disclosed herein, but rather the claims define the full and reasonable scope of the invention.

1. An apparatus for repairing a defective area in a polyimide composite component, comprising:
a flexible film enclosure for covering the defective area of the polyimide composite component;
a seal around a perimeter of the film;
a resin injection assembly for injecting resin between the flexible film enclosure and the defective area of the component; and
a vacuum source for drawing vacuum between the flexible film enclosure and the component.

2. The apparatus of claim 1, further comprising a resin injection machine connected to the resin injection assembly.

3. The apparatus of claim 2, wherein the resin injection assembly comprises a resin line connected to the resin injection machine, a resin nozzle for injecting resin between the flexible film enclosure and the defective area, and a resin plate extending laterally from the resin nozzle for sealing against the flexible film enclosure on one side and guiding flow of resin on the other side.

4. The apparatus of claim 3, wherein the resin nozzle passes through the resin plate.

5. The apparatus of claim 4, wherein the vacuum source comprises a vacuum pump communicated with a space between the flexible film enclosure and the component.

6. The apparatus of claim 3, wherein the resin plate comprises a plate having a shape to match a surface of the defective area.

7. The apparatus of claim 6, wherein the resin plate is flat.

8. The apparatus of claim 1, wherein the flexible film enclosure comprises a material selected from the group consisting of polyimide film, aluminum foil and combinations thereof.

9. The apparatus of claim 1, further comprising a breather structure positioned around a perimeter of the defective area of the component and communicated with the vacuum source.

10. The apparatus of claim 1, further comprising a porous flow media between the resin injection assembly and the defective area.

11. The apparatus of claim 1, further comprising a solid release fabric around a perimeter of the defective area.

12. The apparatus of claim 1, further comprising an additional flexible film enclosure for covering an opposite side of a defective area of a component.

13. The apparatus of claim 12, further comprising an additional seal around a perimeter of the additional flexible film enclosure; an additional resin injection assembly for injecting resin between the additional flexible film enclosure and the opposite side of the defective area of the component;
and a vacuum source for drawing vacuum between the additional flexible film enclosure and the opposite side of the defective area of the component.

14. A method for repairing a defective area of a polyimide composite component, comprising the steps of:
establishing a resin transfer molding area around the defective area; and
injecting resin above a melting temperature of the resin into the defective area.

15. The method of claim 14, further comprising adding a fabric media to the defective area whereby the injecting step injects resin through the fabric media, wherein the fabric media is selected from the group consisting of chopped glass, carbon or quartz fiber, glass, quartz or carbon fabric preforms, continuous glass, quartz or carbon fabric and combinations thereof.

16. (canceled)

17. (canceled)

18. The method of claim 17 15, wherein the fabric media is continuous carbon fabric.

19. The method of claim 14, wherein the step of establishing a resin transfer molding area comprises surrounding the defective area with a flexible film enclosure to define the resin transfer molding area between a component surface and the flexible film enclosure.

20. The method of claim 19, wherein the injecting step comprises injecting the resin through a resin inlet into the resin transfer molding area.

21. The method of claim 20, further comprising holding vacuum in the resin transfer molding area wherein the flexible film enclosure is pulled toward the component around the defective area.

22. (canceled)

23. (canceled)

24. (canceled)

25. (canceled)

26. (canceled)

27. (canceled)

28. The method of claim 14, further comprising, before the step of establishing the resin transfer molding area, applying a release fabric around a perimeter of the defective area, and then applying a porous flow media over the defective area and overlapping the release fabric, wherein the injecting step injects resin through the porous flow media and into the defective area, and further comprising removing the release fabric and the perforated release fabric after the injecting step whereby excess resin is removed.

29. (canceled)
